(19) United States
(12) Patent Application Publication
(10) Pub. No.: US 2007/0251461 A1
(43) Pub. Date: Nov. 1, 2007

(54) Remote Aquatic Environment Control And Monitoring Systems, Processes, and Methods of Use Thereof

(75) Inventors: Christopher D. Reichard, Houston, TX (US); E. Wayne Kinsey, Houston, TX (US); David Harry, Katy, TX (US)

Correspondence Address: LOCKE LIDDELL & SAPP LLP;ATTN: IP DOCKETING, 600 TRAVIS, 3400 CHASE TOWER, HOUSTON, TX, 77002-3095, US

(73) Assignee: Biomatix Systems, Houston, TX (US)

(21) Appl. No.: 11/742,580

(22) Filed: Apr. 30, 2007

Related U.S. Application Data
(60) Provisional application No. 60/746,013, filed on Apr. 28, 2006.

(51) Int. Cl. A01K 63/00

(52) U.S. Cl. 119/245

(57) ABSTRACT

The present disclosure presents methods, systems, and assemblies for the near real-time remote monitoring of aquatic environments, particularly domestic aquatic environments such as aquariums and backyard ponds, using remotely located computer communication systems and control assemblies and software connected by a standard Internet connection and capable of bilateral transfer and interpretation of status files. Also presented herein are business processes of remotely managing, monitoring, and/or controlling the environmental parameters of aquatic environments using electronic control systems installed in the aquarium in combination with a remotely located control system, wherein the two systems are in communication through an Internet connection.

### CROSS REFERENCE TO RELATED APPLICATIONS

The present application claims priority to U.S. Provisional Patent Application Ser. No. 60/746,013, filed Apr. 28, 2006, the contents of all of which are incorporated herein by reference in their entirety.

### STATEMENT REGARDING FEDERALLY SPONSORED RESEARCH OR DEVELOPMENT

Not Applicable.

### REFERENCE TO APPENDIX

Not Applicable.

### BACKGROUND OF THE INVENTION

1. Field of the Invention

This disclosure relates generally to systems, methods, and assemblies for the remote monitoring of aquatic environments, and more particularly, to electronic systems and methods and their associated devices for the remote monitoring and controlling of parameters in aquatic environments in near real-time.

2. Description of the Related Art

Aquariums or aqua systems, such as domestic landscape ponds, of various sizes have been around for many years, and continue to attract interest. Such aquatic environments often include a variety of aquatic organisms and associated environmental systems, such as salt-water and fresh-water aquariums, which are expensive to own, and often both time-intensive and labor intensive with regard to their maintenance. In some instances, a slight change in the environmental conditions within the aquatic environment can result in a loss of the marine organisms contained therein. As a result, a number of approaches to assist the aquatic environment owner in maintaining and monitoring the conditions within the environment have been developed.

For example, several software and hardware devices for monitoring and controlling the environmental parameters of the aquatic environments are known in the art. These local monitoring systems typically evaluate physical properties of the aquarium such as temperature, pH and salinity and provide alerts at the local level when one or more of the target parameters exceed a predefined threshold. While these monitoring systems are adequate for managing single aquatic environments, such as aquariums in the home or office, no such system exists which allows a single person or company to monitor the condition of multiple controllers, all remotely located throughout a specific geographic region, and in near real-time.

While the prior art of monitoring and control systems for aquatic environments provide, in many instances, useful tools for managing the parameters of a single aquatic environment, there remains a need in the art to manage multiple controllers via a single centralized command center, coordinate and organize the data related to each remotely located controller in a manner which facilitates efficient information transfer to the operator of the central command center, provide trained personnel to manipulate the software and hardware settings of the remotely located controllers via the centralized command center in response to normal operating conditions or alerts present in the aquatic environments, and/or dispatch to the location of the aquarium environment the appropriate trained personnel to address abnormalities of the aquarium system as determined by the remotely located controller and Central Command Center software.

This application for patent discloses methods, systems, and assemblies for the remote monitoring and controlling of a plurality of aquatic environments in near real-time, using Internet connectivities.

### BRIEF SUMMARY OF THE INVENTION

In accordance with one embodiment of the present disclose, the present invention is related to business methods and management protocols useful to control and remotely monitor a plurality of control systems in connection with aquatic environments through a single centrally located command center computer. The embodiments of this invention provide a system and business process by which a company may efficiently and effectively maintain and monitor a multitude of aquatic control devices via a single central command center computer operating under customized control and communication software and maintain the health and wellbeing of the inhabitants of the aquatic environments by providing personnel trained in the art aquaria husbandry, marine biology, engineering, chemistry and natural sciences.

In accordance with this aspect of the present disclosure, the central command center computer uses customized software functions and algorithms to communicate with the remote controllers and manage the incoming and outgoing commands associated with environmental parameters of the aquatic environment connected to each independent controller. The central command center may receive data from any of a multitude of remote controllers, 1 to 1000 or more, regarding critical environment or mechanical parameters of the aquatic system. In turn, the central command center process the incoming data and generates alarms or messages specific to the each independent controller and displays the data in manner which effectively communicates the information to the operator, thus allowing the operator to react to the conditions of that single controller. The central command center is simultaneously receiving and processing data from any number of independent controllers currently connected to the central command center system via standard internet communications protocols. This would be a near impossible task if not for the customized algorithms of the central command center software which automatically process and prioritizes all the incoming and outgoing communications.

In further accordance with this aspect of the present disclosure, the central command center provides the ability to manage, prioritize, and manipulate in real-time the control parameters of the network of remotely located aquatic control devices. The system manipulation may include responding to suboptimum temperature conditions by disabling a heating device, conducting routine system maintenance or performing standard preset operations such as turning on/off lighting or water circulation devices. Furthermore in accordance with the embodiments of this invention the management personnel of the company may dispatch trained personnel to address specific parameters of the aquatic environment to maintain the health and well being of the aquaria specimens. These same dispatched, trained personnel may address specific issues with equipment connected to the aquarium environment. Such equipment may be mechanical, electrical, fluidic, structural or of similar nature, or may be used for water filtration, lighting, heating, cooling, pumping water, and the like. Similarly, in accordance with these aspects of the present disclosure, the management personnel of the company may also dispatch trained personnel to address specific issues related to the operation of the automated control system electronics, software or a combination thereof.

In accordance with another embodiment of the present disclosure, the systems of the present disclosure may include electronic temperature or conductivity probes for use in detecting changes in conductivity, temperature, and other aquatic environmental parameters, and which are linked to a microprocessor device which enables near real-time monitoring, control, and data acquisition of such aquatic environmental parameters.

In accordance with a further embodiment of the present disclosure, systems for the remote, near real-time monitoring and controlling of a plurality of aquatic systems are disclosed, wherein the systems comprise a microcontroller device to remotely monitor and control aquatic environmental parameters, and which is connectable to via the Internet to one or more separate and remote human machine interfaces, such as personal computers, PDA's, and the like.

In yet another embodiment of the present disclosure, systems for the near real-time management, control, and monitoring of a plurality of control systems in connection with aquatic environments through a single, centrally located command center computer. In accordance with this embodiment of the present disclosure, a system and process by which a single person or a plurality of people, such as a company, may efficiently and effectively remotely monitor and maintain a plurality of remotely located aquatic control devices using a single command center computer operating under customizable control and communication software.

In a further embodiment of the present disclosure, a process for the remote management, monitoring and control of one or more aquatic environments in near real-time is described, the process comprising obtaining information data from one or more environmental sensors in an aquatic environment using one or more local controller systems; transmitting the information data from the local controller system to a remotely located central computer; processing the information data using an analytical algorithm; and presenting the data to an operator using a human machine interface.

In another embodiment of the present disclosure, a system for the remote monitoring of a plurality of remotely-located aquatic environmental parameters in near real-time is described, the system comprising at least one aquatic environment; one or more probes and sensors capable of measuring parameters of the aquatic environment; a local control system in communication with the one or more probes and sensors; and a remotely located central control computer in communication with analytical software, wherein the local control system and the remotely located central control system are in communication by way of Internet connectivity. Such Internet communication may include the transmission of encrypted, non-encrypted, or both encrypted and non-encrypted data.

In further embodiments of the present disclosure, conductivity probes for measuring the conductivity of liquids are described, the conductivity probes comprising a conductor, a casing substantially enclosing the conductor, communication cables, and a microprocessor, wherein the microprocessor is connected to the conductor within the casing by way of the communication cables.

In other embodiments of the present disclosure, environmentally sealed electronic digital temperature probes are described, the digital temperature probes comprising a digital temperature sensor, one or more USB cables attached to the digital temperature sensor, an electrical communication cable attached to the USB cables, capable of transmitting temperature information to a microprocessor, and an polygonal-shaped enclosure having a proximal end and a distal end longitudinally separated, wherein the USB cables are intermediate between the digital temperature sensor and the electrical communication cable, and wherein at least the digital temperature sensor and the USB cables are housed within the enclosure. In accordance with this general embodiment, an electronic temperature probe for indicating small changes in temperature is described, such electronic temperature probe comprising an enclosure having an extension and connectable to a microprocessor; means for manually setting a fixed reference temperature disposed within the extension for detecting a predetermined change in temperature from the reference temperature; means disposed within the enclosure for indicating the detection of the predetermined change in temperature; and electronic circuit means disposed within the microprocessor and operatively connecting the indicating means in response to the predetermined change in temperature to a remotely located central computer.

In accordance with further embodiments of the present disclosure, a system for the near real-time dynamic monitoring of one or more remote aquatic environments is described, the system comprising a plurality of probes and sensors in communication with the aquatic environment and capable of obtaining analytical data information about the aquatic environment; a local controller enabled for direct connection to the Internet; a remotely located central control computer; and analytical software capable of providing analytical and/or statistical analysis of the analytical data information, wherein the local controller and the remotely located central control computer are in communication by an Internet connection.

In further accordance with the present disclosure, methods of conducting business for the management, remote monitoring, and control of a plurality of aquatic environments from a central monitoring center are described, wherein the method comprises at least providing a plurality of local independent control systems; providing a central control center; transmitting and receiving system data from the plurality of local independent control systems; processing the system data using software at the central control center having analytical algorithms; and presenting the system data relevant to each of the local independent control systems to an operator for monitoring.

In accordance with another embodiment of the present disclosure, methods for remotely monitoring the operation of a plurality of aquatic environments in near real-time are described, the methods comprising acquiring on-line or off-line data measurements of one or more environmental parameters to represent normal operation conditions of the aquatic environment; developing an analytical algorithm or analytical software program corresponding to the normal operation conditions of the aquatic environment; generating detection thresholds from the analytical algorithm or software program and/or from the off-line data measurements of environmental parameters; remotely acquiring on-line measurements of environmental parameters of one or more of the plurality of aquatic environments during normal operation; and determining whether the on-line measurements of environmental parameters are consistent with normal operation of the aquatic environment. In further accordance with this aspect of the disclosure, the off-line and on-line measurements of environmental parameters may be taken from one or more probes and sensors located in, on and around the aquatic environment being remotely monitored. In further accordance with this aspect, the determination of environmental parameter measurement data values outside the predetermined historical “normal” range and associated with abnormal aquatic environmental conditions is capable of triggering an alarm, or alerting an operator of a centralized computer system capable of monitoring the aquatic environment. In accordance with this aspect, the alarm may be a visual alarm, an audible alarm, or a graphic alarm appearing on a display console. Such a graphical alarm may display one or more abnormal aquatic environmental conditions associated with the remotely-located aquatic environment in association with diagnostic graphical displays of data plots indicative of whether the on-line environmental parameters are consistent with normal environmental parameters.

### BRIEF DESCRIPTION OF THE SEVERAL VIEWS OF THE DRAWEINGS

The following figures form part of the present specification and are included to further demonstrate certain aspects of the present invention. The invention may be better understood by reference to one or more of these figures in combination with the detailed description of specific embodiments presented herein.

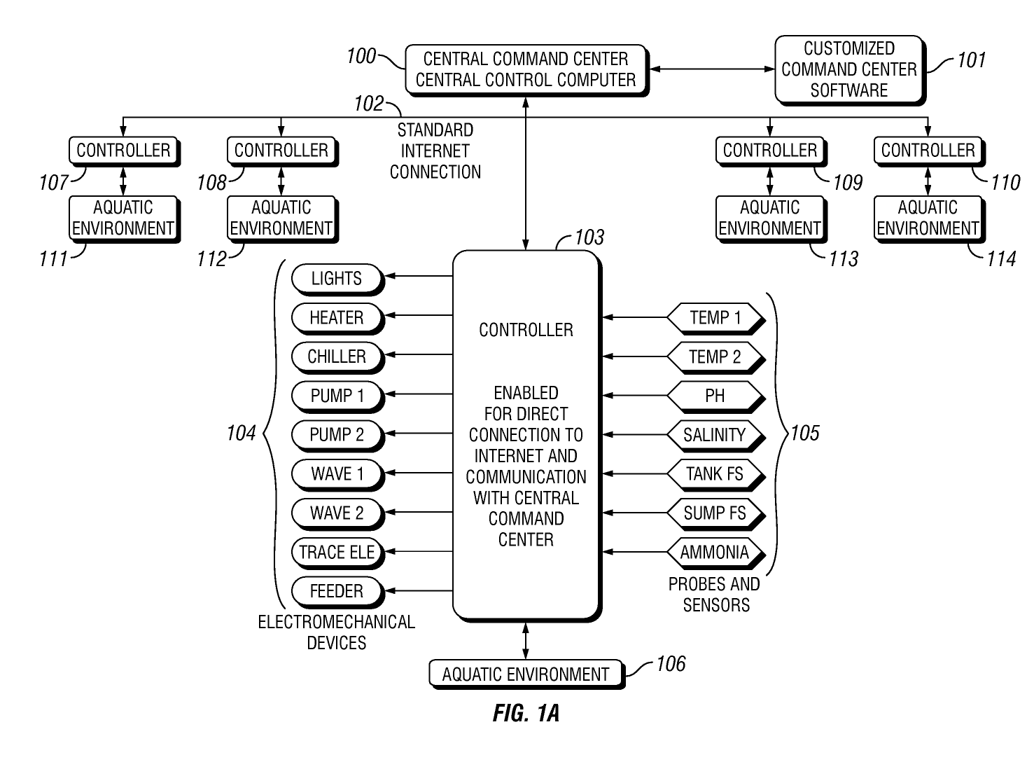

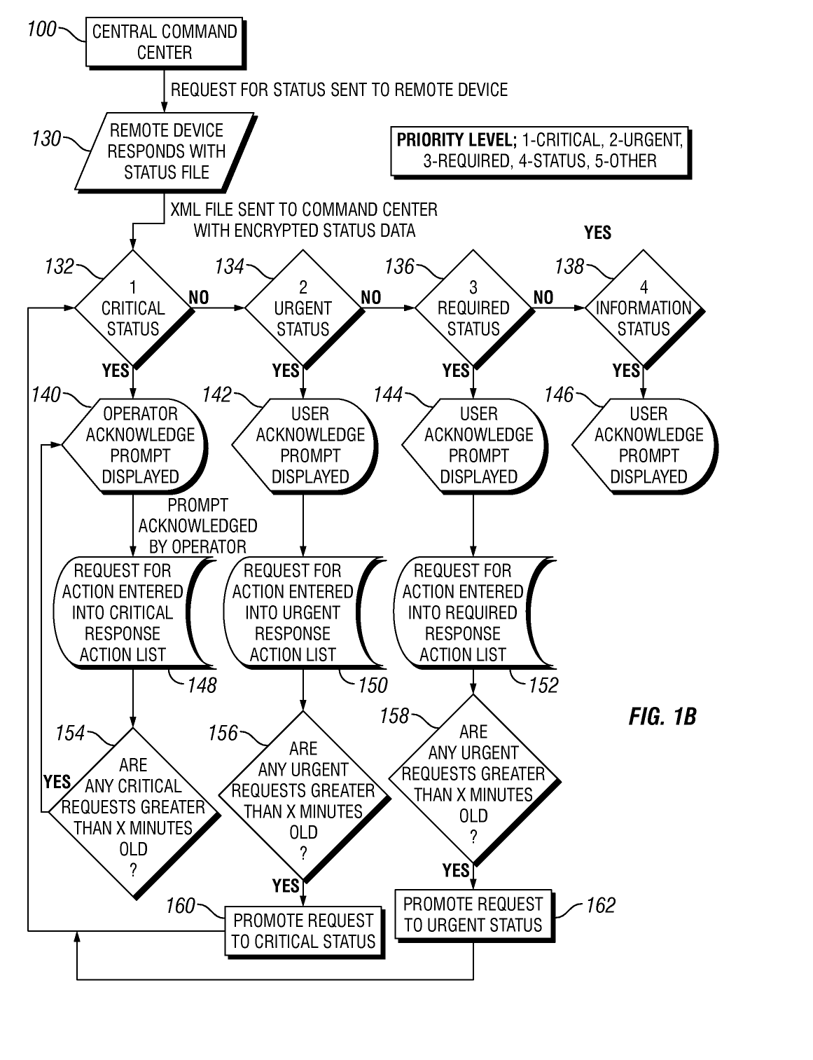

FIG. 1A illustrates a near real-time remote monitoring and control system in accordance with aspects of the present disclosure.

FIG. 1B illustrates an exemplary analytical algorithm in accordance with aspects of the present disclosure.

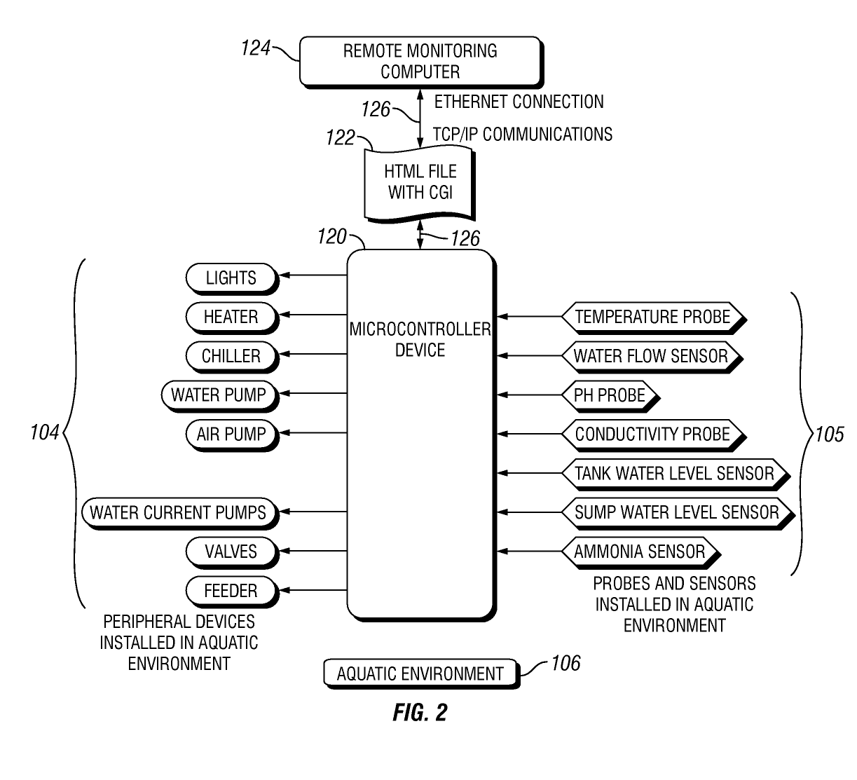

FIG. 2 illustrates a system for remotely monitoring and controlling aquatic environments using a remotely located computer communicating via the Internet, in accordance with an aspect of the present disclosure.

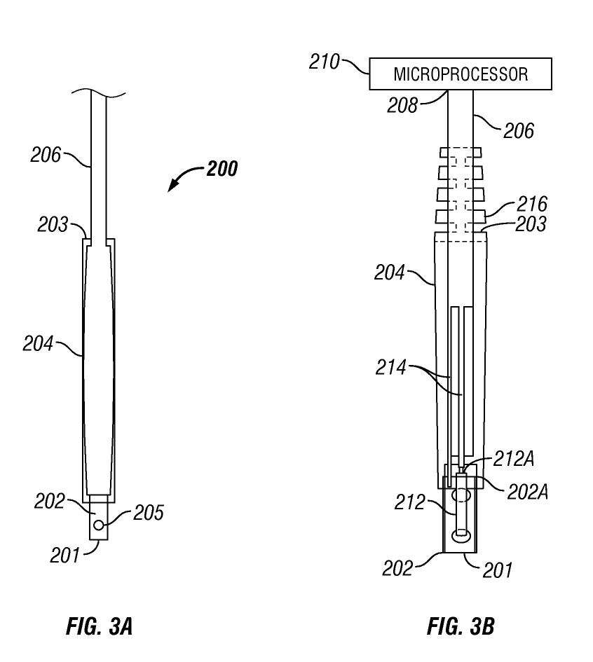

FIG. 3A illustrates an exemplary liquid conductivity probe for use in accordance with aspects of the present disclosure.

FIG. 3B illustrates a partial cross-sectional view of the liquid conductivity probe of FIG. 3A.

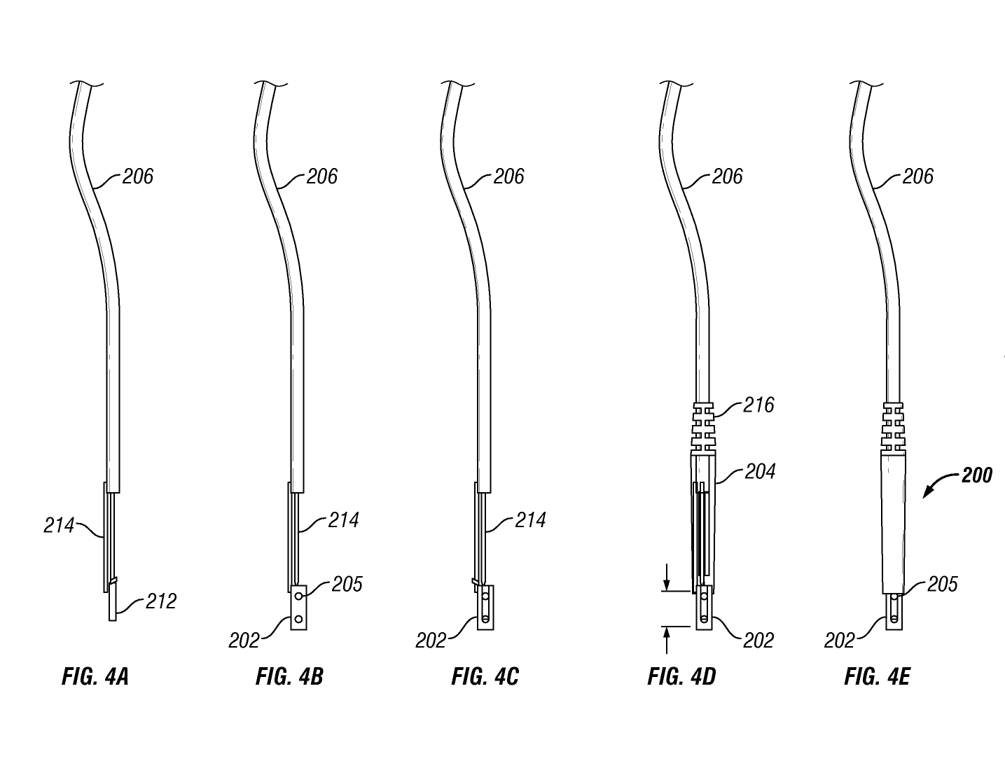

FIGS. 4A-4E illustrate general steps for the manufacture of the probe of FIG. 3A.

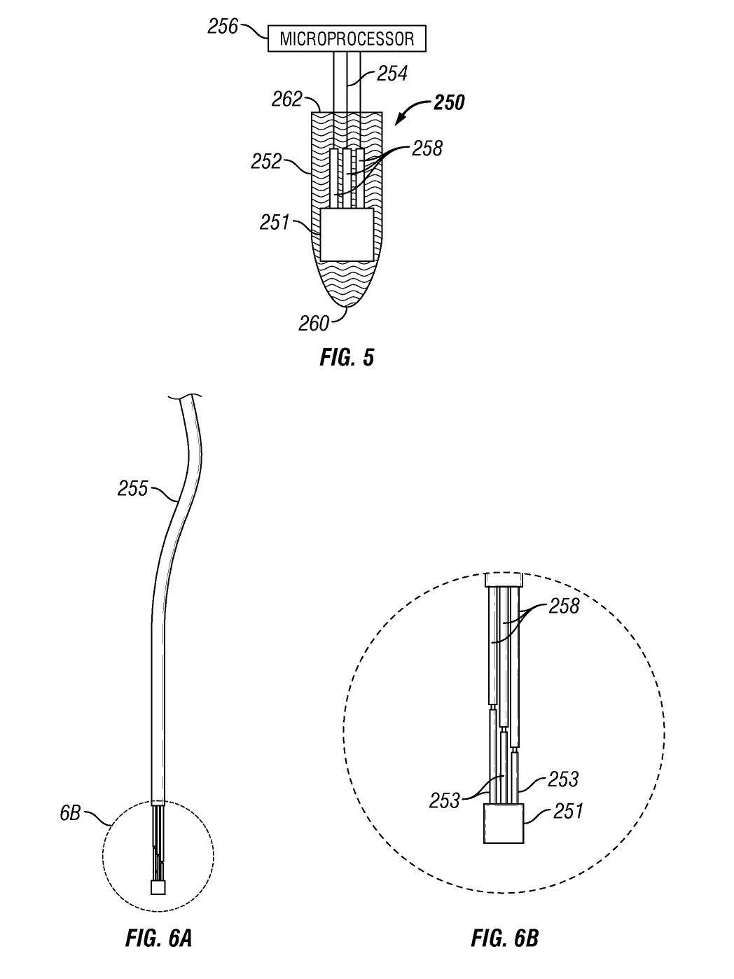

FIG. 5 illustrates an exemplary electronic digital temperature probe in accordance with aspects of the present disclosure.

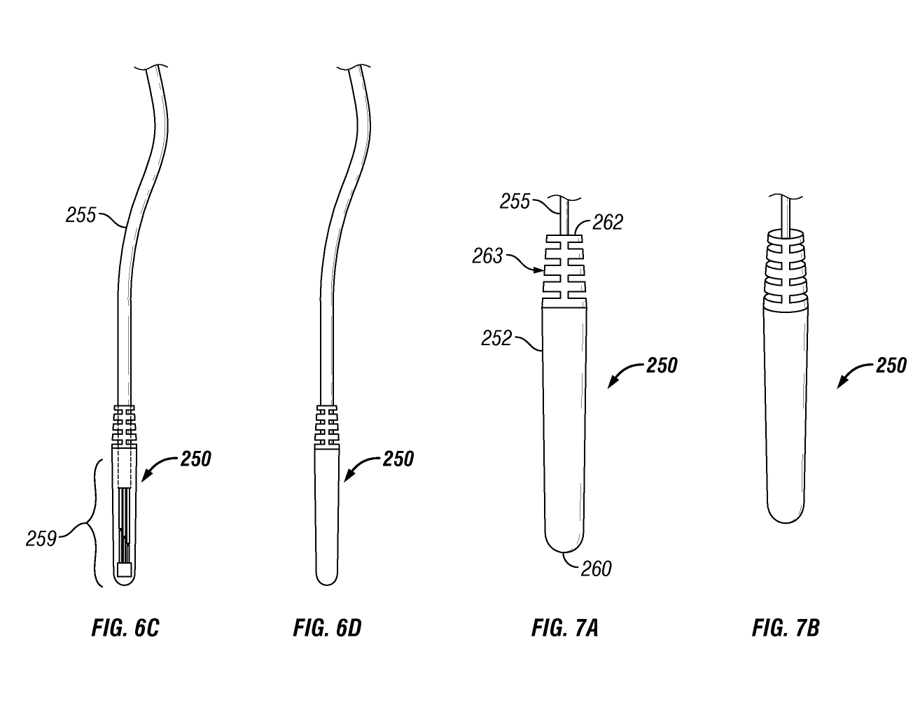

FIGS. 6A-6D illustrate general manufacturing steps for the probe of FIG. 5.

FIG. 7A illustrates a side view of an assembled probe of FIG. 5.

FIG. 7B illustrates a perspective view of an exemplary digital temperature probe in accordance with the present disclosure.

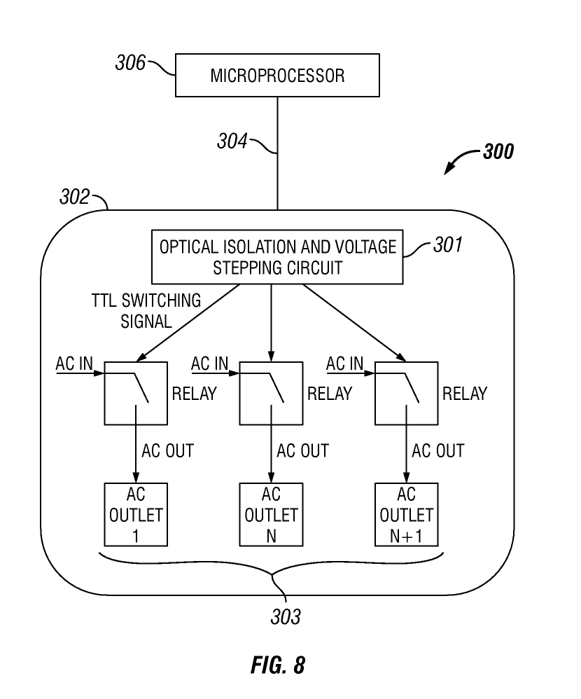

FIG. 8 illustrates a general illustration of an electronic control device for low voltage electronic manipulation of AC outlet circuits, in accordance with aspects of the present disclosure.

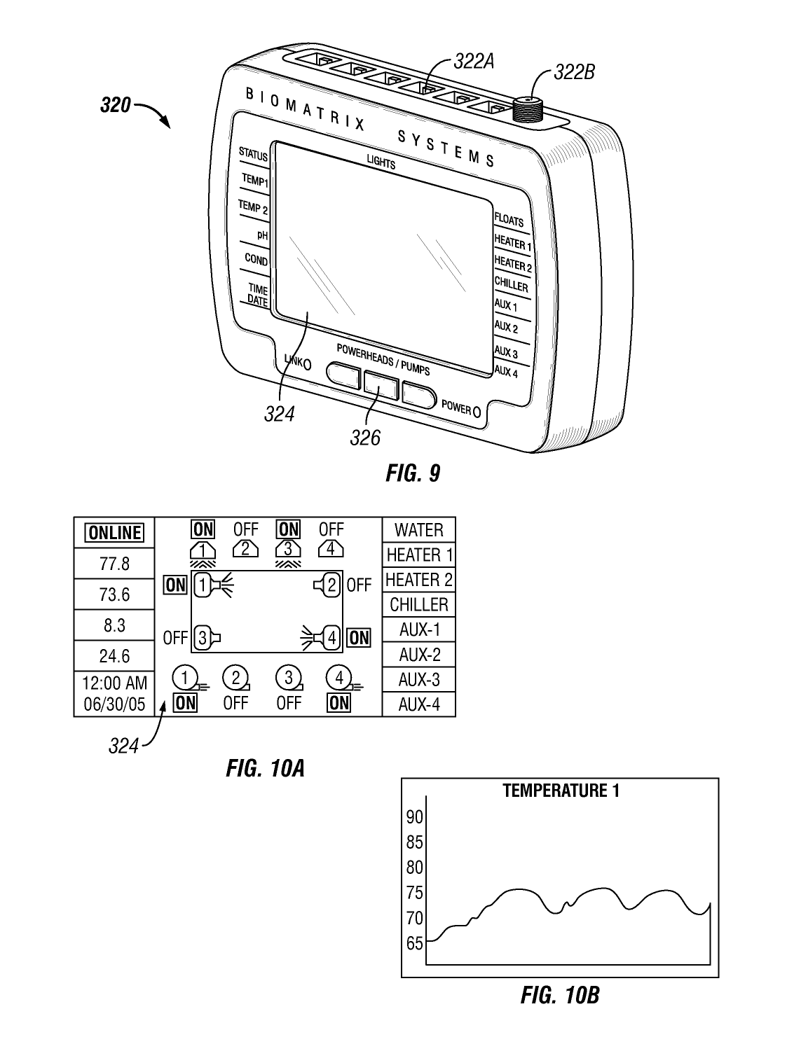

FIG. 9 illustrates an exemplary AC power module and microprocessor suitable for use in the present disclosure.

FIG. 10A illustrates an exemplary graphic display for the device of FIG. 9.

FIG. 10B illustrates an exemplary graphic temperature display for the device of FIG. 9.

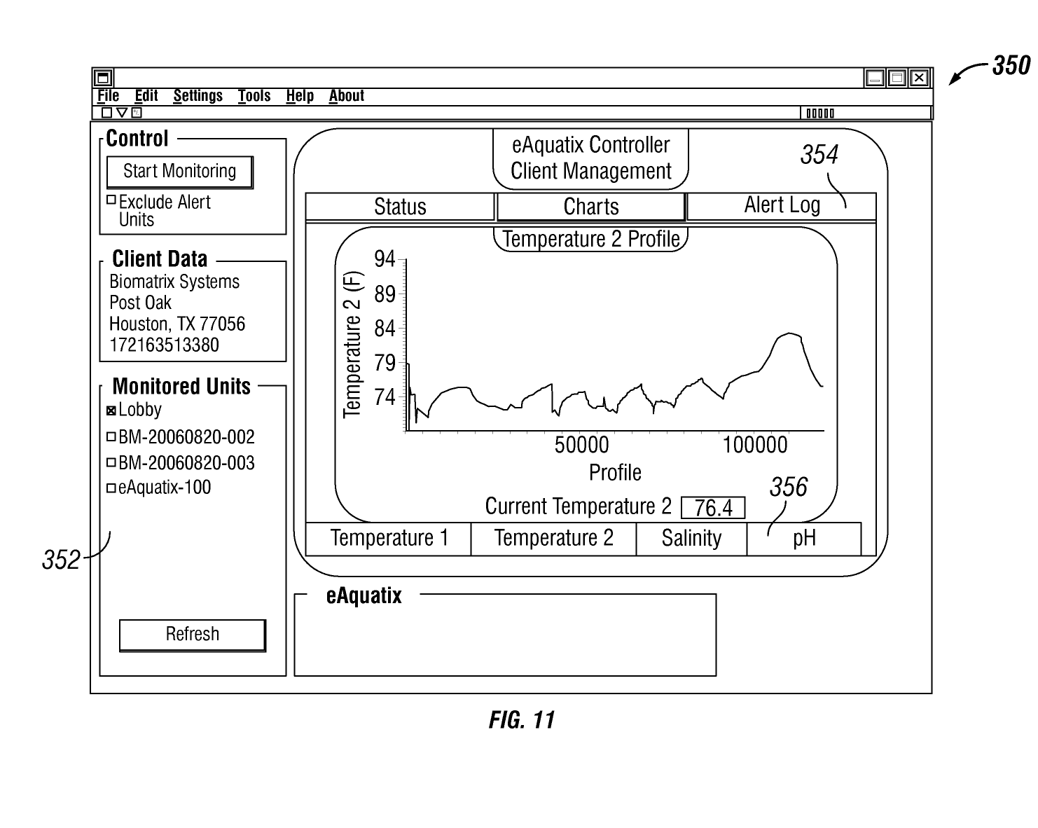

FIG. 11 illustrates an exemplary screenshot of the operator interface of the Central Command Center software.

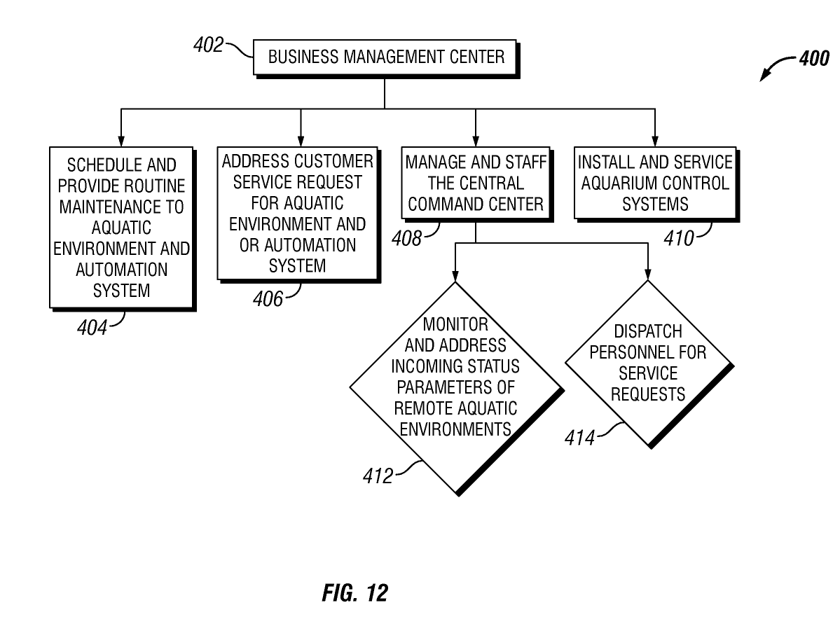

FIG. 12 illustrates a flowchart of a general business management model in accordance with aspects of the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of the present invention. As used in this description and the accompanying claims, the following terms shall have the meaning indicated, unless context otherwise requires.

The term “aqua system”, “aquatic environment”, “aquatic ecosystem”, or “aquarium”, all of these terms being used interchangeably throughout this disclosure, refers to the complex of a community of organisms and its environment functioning as an ecological unit. The terms may include but are not limited to a container (as a glass or plastic (i.e., acrylic) tank capable of housing one or more aquatic organisms), a zoological aquarium or underwater park, or pond (such as a Koi pond or the like) in which aquatic collections of living organisms are kept and/or exhibited, all of which may be of the fresh water or salt water variety.

The terms “electromechanical device” refers to those device which provide, at a minimum, sensor data regarding the environmental parameters of the aquatic environmental systems and electric, mechanical or both electrical and mechanical control of the associated machinery connected to and/or associated with the aquatic systems, including without limitation lighting, heaters, water pumps, filters, and valves.

### DETAILED DESCRIPTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

In general terms, Applicants have created systems, processes, methods, and associated assemblies for the dynamic monitoring, management, and control of a plurality of aquatic environment control systems from a remote location, in near real-time.

Turning now to the figures, FIG. 1A illustrates a plurality of aquatic environments 106, 111, 112, 113 and 114, each of which is shown associated with a local controller system 103, 107, 108, 109 and 110, all of which are connected via a suitable connection system 102, such as an Internet connection, to a central command center 100, housing a central control computer, in accordance with this aspect of the disclosure. Local controllers 103 are preferably enabled for the direct connection to the Internet and communication with at least one central command center 100, and may be a “system” of one or more microcontrollers or the like, or may be a microcontroller as described herein. Also in communication with the local control system 103, 107-110, are a plurality of probes and sensors 105 which are capable of monitoring and measuring a number of parameters within the aquatic environment, including but not limited to temperature (for example, at different depths or locations within the aquatic environment), pH, salinity, redox (reduction-oxidation potential), ozone, carbon dioxide content, trace element (e.g., strontium) amounts, calcium levels, ammonia and urea content, halogenated elemental analysis (e.g., bromine levels), tank filter system (e.g., biological, such as live sand or activated carbon; mechanical, such as canister filter systems; and chemical filter systems) power (e.g., on or off or cycle time) and/or efficiency, and sump pump filter system power (e.g., on or off) and/or efficiency. Furthermore, one or more electromechanical devices 104 associated with the probes and sensors may be provided in the system, and may also be in communication with the local controller using appropriate local communication means, such as controller cables and the like. Suitable electromechanical devices 104 for use in accordance with the present disclosure include but are not limited to lights, heaters, chillers, water pumps, air pumps, wave producing machines, water current pumps, valves, feeders, and trace element and other chemical dispensing devices. In the exemplary embodiment illustrated in FIG. 1, the controller 103, 107-110 on each independent aquatic environment 106, 111, 112, 113 and 114 is in communication via an appropriate remote communication means, such as a standard Internet connection 102, with the central command center 100. The central control center 100, preferably housing one or more central control computers, then transmits data to the customized command center software 101 for processing and analysis, using any suitable transmission means which allows for information communication between the computer(s) within central command center 100 and the software 101. This system as illustrated in FIG. 1 provides the near real-time means to remotely manage and manipulate the operation of the each aquatic environment 106, 111-114 with respect to the specific demands and needs of each independent environment. This system also illustrates how control devices, such as controller 103 and the associated electromechanical devices 104, can be remotely managed in groups in near real-time via an Internet connection between the controllers' microprocessor and a remotely located computer operating the custom communications software, i.e., the Central Command Center system 100.

The command center software 101 is preferably a customizable software, and one which is capable of near real-time analysis. The central command center software 101 is typically a customized computer program, or series of programs in communication with each other, which implement custom software algorithms in order to decode the incoming Extensible Markup Language (XML)-based communication files that are received from each aquatic controller, 103. This incoming information data received from the one or more aquatic probes and/or sensors 105 via intermediate controller 103 may then be stored in a separate database (such as a data historian, not shown) in a format appropriate for associating the data with the specific aquatic controller that generated the data. In this manner, a “history” is continually stored and updated, based on the continued data transmissions to the central command center 100. Additionally, and in accordance with the aspects of the present disclosure, this historical data may then be recalled and displayed on the graphical user interface of the central command center software 101, such a display being in any appropriate or desired format, including but not limited to table form, chart form, graph form, simple text form, or combinations of such forms. This historical data can also be analyzed by the custom algorithms to identify abnormalities, track historical trends, and forecast and predict potential problems or environmental issues within the remotely-located aquatic environments 106, based on trends in this historical data.

FIG. 1B illustrates generally, and without limitation, an exemplary custom algorithm for use with central command center 100 and generating requests/inquiries for status information (e.g., one or more specifically monitored parameters) to be retrieved from the local controllers (103, 107-110) concerning the remotely located aquatic environments (106, 111, 112, 113, 114), as well as how the system addresses the status information data it receives. As illustrated therein, in a typical status inquiry operation, the central control computer system within the central command center 100 sends a request via a standard internet connection (102) for “environmental status” to one (or more) particular remotely located, local control devices (103). The remote device, by way of the controllers (e.g., microcontroller devices) housed therein, then obtains the appropriate or requested data from the probes and sensors (105) in contact or communication with the aquatic environment (106), encrypts the data using known encryption techniques and programs, generates an XML file, and as shown in process 130, responds to the status inquiry by sending the XML file with encrypted status data to the command center 100. Upon receipt of this information, the central control computer at the central command center 100 undergoes a series of analyses of the data, preferably using the customized software 101, as illustrated in FIG. 1B. In the example shown, the computer may go through decision prompts 132, 134, 136 and 138, in order of priority, to determine the status of the remotely located aquatic environment(s) in question. If the aquatic system being monitored is determined to have a “critical status” (132), such as when one or more of the physical and/or chemical parameters of the aquatic environment 106 are outside the range of acceptable values, then an operator acknowledgment response prompt 140 is generated. If there is prompt acknowledgment by the system operator (e.g., within a predetermined period of time), then action 148 occurs and a request for action to correct the problem is entered into a critical response action list, which is then handled as desired, e.g., an alert is sent to a remote technician who travels to the location of the aquatic environment and remedies the problem. After a predetermined period of time “X”, the system again queries, with prompt 154 to determine if any “critical requests” are greater than “X” minutes old, and if they are, the system sends another acknowledgment prompt to the operator.

Similar paths of inquiry are illustrated in FIG. 1B for “urgent status” inquiries 134, such as when one or more monitored parameters in the aquatic environments are approaching the “critical status” described above, and for “required status” inquiries 136, such as when a time or date sensitive parameter (e.g., light system timer for the environment) needs to be acknowledged. In both of these analysis, similar to the analysis described above, the software algorithm goes through a series of prompts for acknowledgment from the operator (142, 144), entering the requests for action into appropriately allocated action lists (150, 152) such that a remotely located technician can attend to the correction or adjustment of the parameter as appropriate, and determining age of requests by way of time inquiries 156, 158. With regard to the time inquiries, it will be clear from the figure that in the event that either of an “urgent status” or “required status” inquiry are older than a predetermined period of time “X”, the system promotes the operator acknowledgment request to a higher priority level, such as to “critical status” through a status promotion step 160, 162. Finally, if the system is inquiring only for specific information at a given time, such as at information prompt 138, after the information is obtained and recorded/stored on a historian, the system again prompts the operator at prompt 146 to acknowledge receipt of the information.

In an exemplary illustration of the use of the system of FIG. 1A, a homeowner owning a large saltwater aquarium (aquatic environment 106) containing a number of marine species (e.g., fish) is at work when the temperature within the aquarium begins to rise. Local controller 103 receives temperature data at regular intervals from a temperature probe/sensor 105 that is in direct communication with both aquatic environment 106 and local controller 103, and controller 103 transmits this information, via the Internet 102, to central command center 100 and the central control computer housed therein. The central computer analyzes this temperature data using analytical software 101, typically using historical data of the environment 106 stored in data historians or the like, and in the instance that an aberration from the normal “accepted range” is detected, as in this example, an alert is generated which feeds back to the central computer. In response to this unexpected temperature rise, as detected by the software, the central computer communicates (via the Internet) with the local controller 103, which in response automatically turns on an appropriate electromechanical device 104 (or takes other appropriate action), such as a chiller, in order to correct the temperature and bring the aquatic environment 106 back into its normal, stable environmental state. In this manner, the stability of the aquatic environment in the aquarium may be quickly and easily maintained in a remote manner, with minimal detrimental impact on the marine life within the aquatic environment.

The Central Command Center system 100 preferably consists of customized computer hardware and customized software (i.e., 101) which allows for the management of a plurality of remotely located aquatic environment controllers (103, 107, 108, 109, 110). Management of these devices consists of the ability to receive data regarding the physical and environmental properties of the remotely located aquatic environment, and issue commands to the controller in response to the condition of the environment from the Central Command Center 100. Based on the data received from the remote controller the Central Command Center software 101 typically analyzes the status of the aquatic environment and hardware components therein. Furthermore, the Central Command Center 100 preferably serves as the system to manage the extensive network of remotely located controllers (103, 107-110) by providing pertinent data such as error, scheduled maintenance, and system anomalies to the Central Command Center operator in a manner in which it is efficiently displayed for easy of analysis and interpretation by the operator.

In further accordance with the present disclosure, and in direct relation to the system described above with respect to FIG. 1A, a system may be provided, as illustrated in FIG. 2, in which a microcontroller-based device 120 is used to remotely monitor and control the environmental parameters of an aquatic environment 106, such as a fresh or salt water aquatic environment. This system comprises an aquatic environment 106, a plurality of probes and sensors 105 installed in or in communication with the aquatic environment, a number of peripheral electromechanical devices 104 installed in the aquatic environment, similar to those described above in relation to FIG. 1. In accordance with the aspects of this system, the microcontroller device 120, engineering in the usual manner and as will be described in more detail herein, uses a standard TCP/IP protocol stack to connect to the internet using a valid IP address through a local area network via Ethernet connection 126 or through a dial-up modem connection. Upon connection to the internet, the microcontroller device 120 allows the monitoring and control of its internal circuitry and peripheral devices of the microcontroller by sending commands through an Extensible Markup Language (XML) file, which may optionally be coded or not, using an embedded common gateway interface command (CGI) format 122 from a separate (remote) personal computer device 124, such as any human-machine interface (HMI), PDA, or the like.

Upon establishing communications with the microcontroller device 120, the user then has the ability to monitor the data being collected by the microcontroller. This data consists of environmental parameters such as the water temperature, pH, conductivity, salinity, water clarity, water current flow, carbon dioxide content, urea content, and oxygen content which are collected by the external probes and sensors 105.

In the same manner, and in response to environmental parameters outside the normal operating range of the aquatic environment 106, the user may also manipulate the peripheral relay controlled devices, electromechanical devices 104, which are also connected to the microcontroller 120. As indicated previously, these peripheral devices 104 may include any number of fluid pumps, lighting devices, heater devices, liquid cooling devices, automatic feeding devices, water current generating devices, and water filtering devices. Manipulation is performed through the aforementioned XML or CGI file 122. Basic commands are configured within a web browser user interface. The commands are then transmitted to the microcontroller device 120 via internet connection 126, which then executes the commands by employing a pre-programmed web page server, and then manipulates the appropriate peripheral device 104 in order to return the aquatic environment to its normal operating conditions.

A further aspect of the present disclosure is illustrated in the assemblies shown in FIG. 3-8, illustrating representative measurement probes and the methods of construction thereof, for use alone or in combination with the systems, methods, and processes of the present disclosure. FIG. 3A illustrates an exemplary liquid conductivity measurement probe assembly 200, comprising a proximal end 201 and a distal end 203 longitudinally spaced apart, a conductivity sensor sleeve 202 having at least one orifice 205 therethrough in order to effect fluid flow through the conductivity sensor, a conducting pin 212 (not shown), and an electrically insulating sleeve 204. In use, assembly 200 measures the conductivity of a liquid in which it is with direct contact by using the liquid medium to complete an electrical circuit between a conducting pin 212 and a conductivity sensor sleeve 202 surrounding at least a portion of the pin 212. As shown in FIG. 3B, illustrating a partial cut-away of the probe assembly of FIG. 3A, the pin 212 and sensor sleeve 202 both extend outwardly from the proximal end 201 of the assembly, with the upper, distal end 203 of both being encased in an insulating sleeve 204, which substantially circumscribes at least a portion of pin 212 and sensor sleeve 202. As also illustrated in FIG. 3B, pin 212 is attached (such as by soldering or any other appropriate attachment means) by its distal end 212a to one or more USB connectors 214, which may or may not be encased in a protective sleeve. In accordance with one aspect of this embodiment, the sensor sleeve 202 is also attached, such as by soldering at its distal end 202a, to one or more conductors of an electrical cable 206, or one or more USB connectors 214, and the radial sleeve 204 is then formed around the distal ends 212a and 202a. Furthermore, the electrical communication cable 206 may have a mini-B male USB connector or similar connector leading from the lower portion of the assembly 200 towards terminating end 208. The probe assembly 200 may then be connected to a microprocessor 210 via electric communication cable 206, and the conductivity measured by conducting pin 212 is transmitted to microprocessor 210 for processing, viewing, and analysis.

The components of conductive probe assembly 200 may be any number of appropriate materials, including stainless steel, carbon/graphite, glass, titanium, active platinum, or equivalent metal or metallic materials for pin 212, stainless steel or other appropriate metal, including metal alloys for sleeve tip 202, and synthetic (e.g., silicone) or polymeric materials for sleeve 204, including but not limited to polyvinyl chloride (PVC), CPVC, polyethylene (PE), epoxy resins, TEFLON®, and the like. Microprocessor 210 may be any number of suitable, commercially available microcontroller devices capable of interpreting electrical signals from the conducting pin 203, such as any of the microcontroller (MCU) or digital signal controllers (DSC) available from Microchip, such as the Microchip PIC® 18F8722 (Microchip Technology Inc., Chandler, Ariz.). Further, the conductivity assembly 200 may have a measurement range from about 0.01 to about 5,000 μS/cm, depending upon the cell constant and similar constraints of the system. The conductivity probe assemblies of the present disclosure typically can be used in temperature ranges from about −25° F. to about 150° F., at pressures ranging from ambient pressure to about 300 Psi, as appropriate.

Typical applications of assembly 200 include in the monitoring of the conductivity of a variety of aquatic environments to monitor the salinity, such aquatic environments including but not limited to fresh and salt water aquariums, swimming pools, hot tubs, bath tubs, water heaters, ponds, water gardens and other systems which require measurement of fluid conductivity and would benefit from the use of a submersible probe such as the ones described in the present disclosure. For example, assembly 200 can determine conductivity in an aquatic environment by measuring the electrical current that flows when there is a known voltage between the conducting pin 203 and the sleeve tip 202 within the casing. In the event that the conductivity is used to determine the salinity of an aquatic environment, the measurements of salinity from conductivity may provide salinity with an accuracy of ±0.005.

FIGS. 4A-4E illustrate an exemplary, non-limiting method for the manufacture of conductivity probes 200, comprising the steps of combining pin 212 with USB connectors 214 forming at least a part of cable 206, both of which have been threaded through an inner sheath material, after which the joint is soldered, as shown in FIG. 4A. In FIG. 4B, the attachment, using any appropriate attachment means such as solder and the like, of salinity probe tip 202 to the USB connectors 214 in a manner such that probe tip 202 substantially circumscribes the pin 212, is illustrated. At this point, an epoxy, such as 3M 5200 Marine Adhesive Fast Cure Epoxy resin, or any other suitable attachment compound, is applied to join the salinity probe 202 to the pin 212 (FIG. 4C). A molded, exterior sleeve (204), such as made from a polymeric material (PVC), elastomeric material, or the like, is then applied over the top of the pin and salinity probe in step 4D, forming the completed conductivity probe assembly 200 (FIG. 4E). As can be seen therein, the exterior, protective sleeve 204 may optionally comprise a plurality of flexors 216 which can be formed or molded, and which serve to further protect the lower end of the conductivity probe assembly from damaging sharp bends.

FIG. 5 illustrates an integrated circuit, digital thermometer assembly 250 suitable for use with the methods and systems of the instant disclosure. As shown therein, assembly 250 comprises digital temperature sensor 251, such as that available from Dallas Semiconductor (DS18S20 TO-92) and a one or more mini USB's 258, both of which are encased in casing 252 to seal the integrated circuit digital thermometer from the surrounding environment. Casing 252 may be of silicone or any number of polymeric or elastomeric materials, having a proximal end 260 and a distal end 262 which are longitudinally separated, and may be molded, extruded, or formed directly on the thermometer assembly. In accordance with aspects of the present disclosure, both temperature sensor 251 and the one or more USB's 258 are contained within casing 252, and located intermediate between proximal end 260 and distal end 262. In accordance with a further aspect of the present disclosure, temperature sensor 251 has an operating temperature range from about −55° C. to about +125° C. and an accuracy of about ±0.5° C. over the entire range, provides at least 9-bit centigrade temperature measurements, and may have an alarm function with nonvolatile user-programmable upper and lower trigger points.

While casing 252 in FIG. 5 is illustrated to be capsular in shape, this is not meant to be limiting, the casing encompassing sensor 251 and USBs 258 being envisioned to be any number of shapes and sizes, such as cylindrical or polyhedral, as desired by the target end placement or aesthetics. The assembly 250 also comprises a microprocessor 256 connected to digital temperature sensor 251 via one or more electrical cables 254 intermediate between USB connectors 258 and microprocessor 256. In the course of use, temperature sensor 251 sensing the temperature of the water surrounding assembly 250 in the aquatic environment, and the temperature value is transmitted to microprocessor 256 for reading, viewing, and, as necessary, further transmission to a remotely located computer center for analysis as described herein.

FIG. 6 illustrates a general, non-limiting method of manufacturing the digital temperature assembly 250, in accordance with aspects of the present disclosure. In FIG. 6A, the lower portion of which “A” is illustrated in detail in FIG. 6B, the digital temperature sensor 251 is preferably connected to one or more (in the illustration, three) USB pins 258 via the temperature sensor connectors 253 using an appropriate attachment means, such as a solder joint with flux. The USB pins 258 are preferably covered with a sheath, 255, the combination of the USB pins connected to the temperature sensor 251 comprising at least one electrical cable 254. As illustrated in the cut-away of the next step, shown in FIG. 6C, the interior temperature sensor assembly 259 comprising digital temperature sensor 251 and USB's 258 are covered by an exterior casing 252, which substantially circumscribes and covers sensor 251 and USB's extending from the end of cable 254, as shown therein. The completed temperature sensor assembly 250 is shown in FIG. 6D.

In FIG. 7A, a side view of assembled digital temperature sensor assembly 250 from FIG. 6 is shown, illustrating sheath 255 containing the one or more mini-USB cables 258 entering the distal end 262 of the assembly. FIG. 7A also illustrates an alternative embodiment of the assembly 250 of the present disclosure, wherein the distal end 262 further comprises formed flexors 263 which allow for the movement of the sheath 252, and which also protect cables 258 at their entrance into casing 252, so as to provide longer service life for the assembly. FIG. 7B illustrates the assembly 250 of FIG. 7A in perspective, illustrating casing 252 with a generally cylindrical, non-limiting tube-like shape.

FIG. 8 illustrates an exemplary electronic device 300 employing transmitor-to-transistor level communications logic to open and close alternating current (AC) circuits, in accordance with aspects of the present disclosure. Device 300 comprises an AC power module 302 comprising a bank of alternating current (AC) outlet circuits 303, which preferably comprise an optical isolation and voltage stepping circuit 301 and no less than one outlet to any of a multitude of outlets. Module 302 is connected to a microprocessor device 306, such as the Microchip PIC® 18F8722 (available from Microchip Technology Inc., Chandler Ariz.) or any other device capable of generating and transmitting the transistor-to-transistor level logic necessary to operate the switching relay, by way of one or more conductor cables 304, such as a ten conductor cable having an RJ-45 type connector and utilizing custom pinout configurations. In operation, the microcontroller device 300 sends transistor-to-transistor level signals to the AC relay bank 303 to open and/or close the appropriate circuit, as necessary. Device 300 may be used, for example, in the remote control of one or more electromechanical devices (e.g., 104 in FIG. 1) in response to signals received from the previously discussed custom software algorithms. In accordance with certain aspects of the present disclosure, device 300 may be used in combination with a microprocessor device as described above, which communicates through digital transistor-to-transistor level logic and analog signals to the integrated peripheral input and output circuits associated with the probes and sensors 105. Data acquired from these circuits may be processed by the custom software algorithms, which may optionally be stored directly on the microprocessor devices themselves, and the data is then appropriately displayed on the graphical liquid crystal display of an assembly, such as assembly 320.

In FIG. 9, an exemplary assembly 320 for use with the systems and methods of the present disclosure is illustrated, assembly 320 being a compact encasement containing at least the microprocessors described herein, peripheral circuits, a graphical LCD screen 324 with a plurality of user input buttons 326 on the outer face, and access connectors 322a, 322b, for integrating connectors for Ethernet or Internet communication, temperature probes, conductivity probes, digital inputs, digital outputs, and the like with assembly 320. FIG. 10A illustrates an exemplary graphical liquid crystal display 324 of assembly 320, showing exemplary data which can be displayed to the user, including but not limited to power levels, temperatures, pump status, and the like. In FIG. 10B, an exemplary temperature plot which can be displayed on display screen 324 is shown, illustrating a display of aquarium water temperature over time, as received from a digital temperature probe or the like as described herein.

As detailed above, the systems, methods and processes detailed herein can be used for the near real-time remote monitoring of a variety of systems, such as aquatic environments, preferably using one or more remotely located central command, or management centers, such as centers 100 in FIG. 1. In FIG. 11, an exemplary screen-shot 350 of a client management system associated with the computer at center 100 is shown, illustrating the typical display which may be viewed by the operator. As shown therein, the operator may select which units to monitor using the selection fields 352. For each selected unit monitored, the operator may also view various physical, chemical, or mechanical profiles 352 of the aquatic environment 106 being monitored, the profiles of which may be displayed graphically similar to display 358. Also available for optional viewing are status, chart, and alert logs 354, which may provide detailed histories of the environment 106 as necessary.

The methods, systems, and processes, as well as the associated assemblies described herein, may be used to generate a business management method and model 400, as illustrated generally in FIG. 12. Referring to the figure, such a method 400 comprises at least one centralized management center 402, as well as a variety of associated protocols for managing a remotely-operated aquatic environment monitoring business. Center 402 is typically the remotely located control center housing the one or more computer systems which may be used in the receipt and interpretation of environmental data provided by local controllers from the aquatic environments being monitored. In addition to the remote monitoring and control of a plurality of aquatic environments, as described herein, the systems and methods may also provide a hands-on type of management of the various accounts, including scheduling and providing routine maintenance to the aquatic environments and the associated automation systems described herein (404), addressing customer service requests for aquatic environment monitoring or automation systems use and operation (406), managing and staffing the central command center(s) (408), and installing and servicing the plurality of aquatic control systems (410), such as those systems described herein. As illustrated in FIG. 12, the managing and staffing of the central command center may further include both monitoring and addressing incoming status parameters of the plurality of remote aquatic environments by one or more individuals (412), as well as monitoring and dispatching personnel for performing maintenance, repair, and correction requests (414).

In view of the methods illustrated in FIG. 12, a business process for the dynamic management, monitoring and control of a multitude of aquatic environments from a central center is disclosed, the method comprising remotely managing a multitude of aquatic environment control systems, the method comprising transmitting, receiving and analyzing system data from each independent local control system; processing the data via the functions and algorithms of a customized command center software package; and presenting the data relevant to each independent controller to the operator in a manner relevant to the efficient management of the multitude of controllers currently communication with the central command center. In accordance with this aspect of the present disclosure, the method further comprises business processes by which trained personnel may be dispatched, such as via telephone, computer, or handheld communication device, to address any number of environmental issues related to the health and well-being of inhabitants of aquatic environments which are determined to be important based on the analysis of the system data from the independent, local control systems. In similar accordance with this business process by, trained personnel may also install automated aquarium control systems on aquatic environments, and/or be dispatched to respond to alerts raised by sensors and data generated by the automated aquarium control systems. Additionally, such business processes may also include creation and maintenance of a central command Center (e.g., 100) housing one or more central control computer systems, Internet providers or servers, and the associated software, wherein such command center is organized to manage and triage incoming data from the automated, remotely-operated aquarium control systems described herein, wherein the command center is staffed and operated by trained personnel.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Prophetic Example 1

### Method of Managing Multiple Controllers Via the Central Command Center

In this example, as illustrated generally in FIG. 1, a multitude of independent controllers are each connected, via the Internet, to the Central Command Center. In this example it is assumed the total number of controllers being simultaneously managed by the Central Command Center is 100 independent controllers. In the event of a system error on the 45^{th} independent controller, the customized command center software would immediately post the error to the forefront of the command center priority list. At that point the operator would be able to react and remedy the error from the remote site via the central command center software. Additionally, the command center maintains its connection and communication with the other 99 controllers while the operator is manipulating controller #45. If during this process additional error signals are received from any of the other 99 controllers, the command center software 101 would also bring each alert to the immediate attention of the operator. Conversely, if the operator did not have the invention described herein, they would have to individually connect to each of the 100 controllers and manually and systematically check the status of each controller and aquatic system. It is therefore clear that without the invention present herein, the task of remotely monitoring and managing multiple controllers via the internet would be extremely time consuming, cost prohibitive, and tedious if not impossible.

### Prophetic Example 2

### Remote Control of an Individual Output of an Aquarium Control Device by Hypertext Transfer Protocol Communication of a CGI File Generated by a Remote Control Device

In this example, as illustrated generally in reference to FIG. 2, a CGI file is generated by an embedded web server of the control device which is connected to a local area network (LAN) or the Internet via a standard Ethernet connection. The data of the file is interpreted by a standard web browser application, such as Microsoft Internet Explorer® running on a personal computer connected to a local area network or the Internet. At that point, the operator of the system may make adjustments to the data presented and return the data to the remote device 120, where it is processed by an appropriate processor, such as an embedded webserver and the accompanying software code. In this manner, the operator may manipulate the peripheral relay control devices 104 which are connected to the remote, microprocessor control device 120. The basic commands that are configured within a web browser user interface and are transmitted to the microcontroller device may then be executed by employing a pre-programmed web page server, as appropriate.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

What is claimed is:

1. A process for the remote management, monitoring and control of one or more aquatic environments in near real-time, the process comprising:
obtaining information data from one or more environmental sensors in an aquatic environment using one or more local controller systems;
transmitting the information data from the local controller system to a remotely located central computer;
processing the information data using an analytical algorithm; and
presenting the data to an operator using a human machine interface.

2. The process of claim 1, wherein the information data is transmitted as Extensible Markup Language (XML)-based communication files through the Internet.

3. The process of claim 2, wherein the information is encrypted.

4. The process of claim 1, further comprising transmitting instruction in response to the information data from the central computer to the local controller system to a plurality of electromechanical devices in communication with the local control system, the plurality of electromechanical devices capable of operating in response to instructions from the central control computer.

5. The process of claim 4, wherein the plurality of electromechanical devices operate singly or in combination.

6. The process of claim 1, wherein the one or more environmental sensors include temperature sensors, pH sensors, salinity and/or conductivity sensors, ammonia sensors, urea sensors, biological growth sensors, tank sensors, and sump sensors.

7. A system for the remote monitoring of a plurality of remotely-located aquatic environmental parameters in near real-time, the system comprising:
an aquatic environment;
one or more probes and sensors capable of measuring parameters of the aquatic environment;
a local control system in communication with the one or more probes and sensors; and
a remotely located central control computer in communication with analytical software;
wherein the local control system and the remotely located central control system are in communication by way of Internet connectivity.

8. The system of claim 7, wherein the aquatic environment is a fresh water aquarium, a salt water aquarium, a pond, or a hot tub.

9. The system of claim 7, wherein the one or more probes and sensors are selected from the group consisting of temperature sensors, pH sensors, salinity and/or conductivity sensors, ammonia sensors, urea sensors, trace element sensors, oxygen sensors, biological growth sensors, tank sensors, light sensors, and sump sensors.

10. The system of claim 7, further comprising a plurality of electromechanical devices in communication with the local control system, and capable of operating in response to instructions from the central control computer.

11. A conductivity probe, comprising:
a conductor;
a casing substantially enclosing the conductor;
communication cables; and
a microprocessor;
wherein the microprocessor is connected to the conductor within the casing by way of the communication cables.

12. An environmentally sealed electronic digital temperature probe comprising:
a digital temperature sensor;
one or more USB cables attached to the digital temperature sensor;
an electrical communication cable attached to the USB cables, capable of transmitting temperature information to a microprocessor; and
an polygonal-shaped enclosure having a proximal end and a distal end longitudinally separated,
wherein the USB cables are intermediate between the digital temperature sensor and the electrical communication cable, and
wherein at least the digital temperature sensor and the USB cables are housed within the enclosure.

13. An electronic temperature probe for indicating small changes in temperature, comprising:
an enclosure having an extension and connectable to a microprocessor;
means for manually setting a fixed reference temperature;
disposed within the extension for detecting a predetermined change in temperature from the reference temperature;
means disposed within the enclosure for indicating the detection of the predetermined change in temperature; and
electronic circuit means disposed within the microprocessor and operatively connecting the indicating means in response to the predetermined change in temperature to a remotely located central computer.

14. A system for the near real-time dynamic monitoring of one or more remote aquatic environments, the system comprising:
a plurality of probes and sensors in communication with the aquatic environment and capable of obtaining analytical data information about the aquatic environment;
a local controller enabled for direct connection to the Internet;
a remotely located central control computer; and
analytical software capable of providing analytical and/or statistical analysis of the analytical data information,
wherein the local controller and the remotely located central control computer are in communication by an Internet connection.

15. A method of conducting business for the management, remote monitoring, and control of a plurality of aquatic environments from a central monitoring center, the method comprising:
providing a plurality of local independent control systems;
providing a central control center;
transmitting and receiving system data from the plurality of local independent control systems;
processing the system data using software at the central control center having analytical algorithms; and
presenting the system data relevant to each of the local independent control systems to an operator for monitoring.

16. The method of claim 15, further comprising providing personnel having an understanding of technical properties of aquatic environments which can be dispatched to any one or more of the plurality of aquatic environments in response to one or more alerts generated by sensors and data generated by the aquatic environment control systems.

17. The method of claim 15, wherein the central monitoring center is organized to include one or more trained personnel and which contains computer hardware and software capable of organizing, managing, and interpreting data information received from the plurality of aquatic environments.

18. The method of claim 15, wherein the system data information received is received and transmitted using an Internet connection system.

19. A method for remotely monitoring the operation of a plurality of aquatic environments in near real-time, the method comprising the steps of:
acquiring on-line or off-line data measurements of one or more environmental parameters to represent normal operation conditions of the aquatic environment;
developing an analytical algorithm or analytical software program corresponding to the normal operation conditions of the aquatic environment;
generating detection thresholds from the analytical algorithm or software program and/or from the off-line data measurements of environmental parameters;
remotely acquiring on-line measurements of environmental parameters of one or more of the plurality of aquatic environments during normal operation; and
determining whether the on-line measurements of environmental parameters are consistent with normal operation of the aquatic environment.

20. The method of claim 19, wherein the analytical algorithm is capable of decoding XML-based communication files received from remote controllers.

21. The method of claim 19, wherein the analytical algorithm is a statistical algorithm or statistical model, including multivariate statistical models.

22. The method according to claim 19, wherein the off-line and on-line measurements of environmental parameters include temperature, pH, salinity, conductivity, oxygen content, urea content, ammonia content, and trace element content.

23. The method according to claim 22 in which the off-line and on-line measurements of environmental parameters are taken from one or more probes and sensors located in, on and around the aquatic environment.

24. The method according to claim 19 in which a determination of environmental parameter measurement data values outside the predetermined historical “normal” range and associated with abnormal aquatic environmental conditions triggers an alarm.

25. The method according to claim 24, wherein the alarm is a visual alarm, an audible alarm, or a graphic alarm appearing on a display console.

26. The method according to claim 25, wherein graphical alarm displays of abnormal aquatic environmental conditions associated with a remotely-located aquatic environment are associated with diagnostic graphical displays of data plots indicative of whether the on-line environmental parameters are consistent with normal environmental parameters.
